(19) United States
(12) Patent Application Publication
(10) Pub. No.: US 2019/0354483 A1
(43) Pub. Date: Nov. 21, 2019

(54) CONTROLLER AND MEMORY SYSTEM INCLUDING THE SAME

(71) Applicant: SK hynix Inc., Gyeonggi-do (KR)

(72) Inventors: Yong JIN, Seoul (KR); Young Ho KIM, Gyeonggi-do (KR); Seung Geol BAEK, Gyeonggi-do (KR)

(21) Appl. No.: 16/202,436

(22) Filed: Nov. 28, 2018

(30) Foreign Application Priority Data
May 15, 2018 (KR) 10-2018-0055465

(51) Int. Cl. G06F 12/0804

(52) U.S. Cl. CPC G06F 12/0804; G06F 2212/1016

(57) ABSTRACT

A controller gives priorities to requests received from a plurality of host devices, and processes the requests according to the priorities. The controller includes a credit generation unit configured to generate credits to provide to the respective host devices, based on the numbers of requests received from the respective host devices; a buffer manager configured to give priorities to the respective host devices, based on the credits; and a buffer memory configured to store the requests according to the priorities given to the host devices.

### CROSS-REFERENCE TO RELATED APPLICATION

The present application claims priority under 35 U.S.C. § 119(a) to Korean application number 10-2018-0055465, filed on May 15, 2018, which is incorporated herein by reference in its entirety.

### BACKGROUND

### 1. Technical Field

Various embodiments generally relate to an electronic device, and more particularly, to an electronic device including a controller and a non-transitory machine-readable storage medium.

### 2. Related Art

A memory system may be configured to store the data provided from an external device, in response to a write request from the external device. Also, the memory system may be configured to provide stored data to the external device, in response to a read request from the external device. The external device as an electronic device capable of processing data may include a computer, a digital camera or a mobile phone. The memory system may operate within the external device, or may operate as a separate component coupled to the external device.

A memory system using a memory device provides advantages in that, since there is no mechanical driving part, stability and durability are excellent, information access speed is high and power consumption is small. Memory systems having such advantages include a universal serial bus (USB) memory device, memory cards having various interfaces, a universal flash storage (UFS) device, and a solid state drive (SSD).

### SUMMARY

Various embodiments are directed to a memory system which variably applies the order in which requests of host devices are fetched, based on the workload characteristics of operations corresponding to the requests.

In an embodiment, there is provided a controller which gives priorities to requests received from a plurality of host devices, and processes the requests according to the priorities. The controller may include: a credit generation unit configured to generate credits to provide to the respective host devices, based on the numbers of requests received from the respective host devices; a buffer manager configured to give priorities to the respective host devices, based on the credits; and a buffer memory configured to store the requests according to the priorities given to the host devices.

In an embodiment, the buffer manager determines the priorities for the respective host devices, based on the credits and the properties of the requests.

In an embodiment, the properties are decided according to whether an operation corresponding to the requests is a read operation or write operation.

In an embodiment, a memory system may include: a controller configured to receive requests from a plurality of host devices; and a nonvolatile memory device configured to receive commands corresponding to the requests from the controller, and perform operations corresponding to the commands according to control of the controller. The controller may include: a credit generation unit configured to generate credits to provide to the respective host devices, based on the numbers of requests received from the respective host devices; a control unit configured to set priorities of the commands to transfer to the nonvolatile memory device, based on the credits; and a memory control unit configured to transfer the commands to the nonvolatile memory device based on the set priorities.

In an embodiment, the control component determines the priorities for the respective host devices, based on the credits and the properties of the requests.

In an embodiment, the properties are decided according to whether an operation corresponding to the requests is a read operation or write operation.

In an embodiment, there is provided a data processing system comprising: a plurality of host devices; and a memory system including a memory device, and a controller configured to receive requests from the plurality of host devices and control the memory device to perform operations corresponding to the requests, the controller including a buffer memory with a plurality of slots and being further configured to: determine credits for the respective host devices based on an access pattern of the buffer memory; and fetch the requests from the host devices to store the fetched requests in the buffer memory in accordance with an order determined based on the credits and available buffer memory slots among the plurality of buffer memory slots.

### BRIEF DESCRIPTION OF THE DRAWINGS

FIG. 1 is a block diagram illustrating a data processing system including a controller and a memory system in accordance with an embodiment.

FIG. 2A illustrates an operation in which credits are reallocated to queues in each set cycle in accordance with an embodiment.

FIG. 2B illustrates an operation in which credits are reallocated to queues after data stored in a buffer memory are flushed to a nonvolatile memory device in accordance with an embodiment.

FIG. 3 illustrates an operation in which a total credit is variably generated when credits are reallocated in accordance with an embodiment.

FIG. 4 illustrates an operation in which a plurality of requests is stored in a plurality of queues in accordance with an embodiment.

FIG. 5 is a graph illustrating available buffer memory slots depending on time, when requests are fetched in a round robin manner to access a buffer memory, in accordance with an embodiment.

FIG. 6 is a graph illustrating credits of the respective queues and available buffer memory slots, when requests are fetched to access a buffer memory, in accordance with an embodiment.

FIG. 7 is a diagram illustrating a data processing system including a solid state drive (SSD) in accordance with an embodiment.

FIG. 8 is a diagram illustrating a data processing system including a memory system in accordance with an embodiment.

FIG. 9 is a diagram illustrating a data processing system including a memory system in accordance with an embodiment.

FIG. 10 is a diagram illustrating a network system including a memory system in accordance with an embodiment.

FIG. 11 is a block diagram illustrating a nonvolatile memory device included in a memory system in accordance with an embodiment.

### DETAILED DESCRIPTION

A controller and a memory system including the same according to embodiments of the present disclosure will be described below with reference to the accompanying drawings through various embodiments.

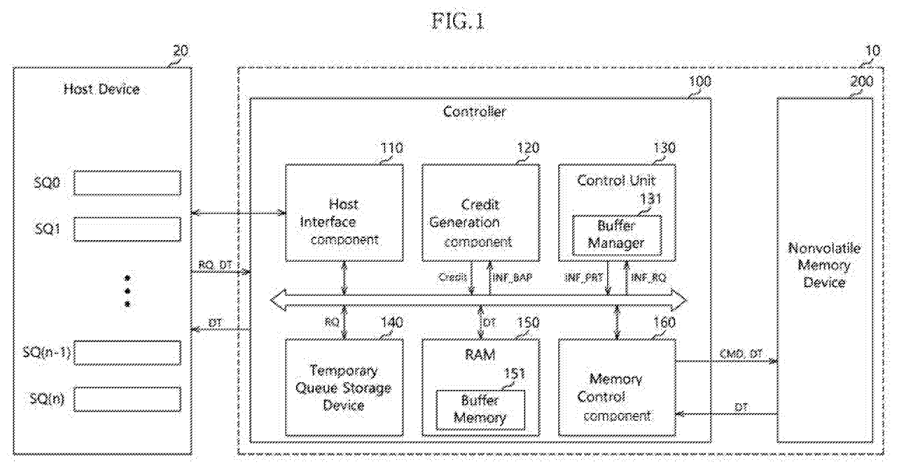

FIG. 1 is a block diagram illustrating a data processing system in accordance with an embodiment. Referring to FIG. 1, the data processing system may include a memory system 10 and a host device 20.

The host device 20 may include a plurality of submission queues SQ0 to SQn and a completion queue (not illustrated). The submission queues SQ0 to SQn may transfer input and output (I/O) commands (for example, read and write requests) to the memory system 10. The completion queue may receive the completion statuses of the I/O requests from the memory system 10. As described later, requests fetched from the plurality of submission queues SQ0 to SQn (queues) may be efficiently shared by the memory system 10. In the present specification, the plurality of queues SQ0 to SQn may indicate a plurality of host devices 20. That is, the plurality of queues SQ0 to SQn may indicate a plurality of queues installed in a plurality of host devices 20 respectively, and requests received from the plurality of queues SQ0 to SQn may indicate requests received from the plurality of host devices 20.

The host device 20 and the memory system 10 may provide a high input and output (I/O) bandwidth using the plurality of queues SQ0 to SQn. That is, the host device 20 may store I/O requests for the memory system 10 in the plurality of queues SQ0 to SQn, and transfer the I/O requests stored in the plurality of queues SQ0 to SQn to the memory system 10. The memory system 10 may process the I/O requests received from the plurality of queues SQ0 to SQn in parallel, and perform data read and write operations in response to the I/O requests.

The memory system 10 may store data which are accessed by the host device(s) 20, each of may be any of a mobile phone, MP3 player, laptop computer, desktop computer, game machine, television (TV) and in-vehicle infotainment system.

The memory system 10 may be fabricated as any one of various storage devices, depending on a host interface indicating a transmission protocol with the host device 20. For example, the memory system 10 may be implemented with any one of various storage devices such as an SSD, a multi-media card (e.g., MMC, eMMC, RS-MMC or micro-MMC), a secure digital card (e.g., SD, mini-SD or micro-SD), a universal storage bus (USB) storage device, a universal flash storage (UFS) device, a personal computer memory card international association (PCMCIA) storage device, a peripheral component interconnection (PCI) storage device, a PCI express (PCI-e or PCIe) storage device, a compact flash (CF) card, a smart media card and a memory stick.

The memory system 10 may be fabricated as any one of various types of packages. For example, the memory system 10 may be implemented with any one of various types of packages such as a package on package (POP), a system on chip (SOC), a multi-chip package (MCP), a chip on board (COB), a wafer-level fabricated package (WFP) and a wafer-level stack package (WSP).

The memory system 10 may include a controller 100 and a nonvolatile memory device 200. In an embodiment, the controller 100 may include a host interface 110, a credit generator 120, a control component 130, a temporary queue storage device 140, a random access memory (RAM) 150 and a memory control component 160. The RAM 150 may include a buffer memory 151.

The host interface 110 may interface the host device 20 and the memory system 10. For example, the host interface 110 may communicate with the host device 20 using any one of a numerous standard transmission protocols, i.e., the host interface. The standard transmission protocols may be any of secure digital, USB, MMC, eMMC, PCMCIA, parallel advanced technology attachment (PATA), serial advanced technology attachment (SATA), small computer system interface (SCSI), serial attached SCSI (SAS), PCI, PCI-e and UFS.

In an embodiment, the controller 100 may receive a specific request RQ from the host device 20, and fetch a request RQ from a queue included in the host device 20 in response to the received request RQ. The request RQ may include a message indicating that a command CMD to be transferred to the nonvolatile memory device 200 was generated. In response to the specific request RQ, the controller 100 may fetch a request RQ stored in a specific queue of the host device 20 through the host interface 110. In an embodiment, the fetched request RQ may include data required for performing an operation corresponding to the fetched request RQ. In an embodiment, the plurality of queues SQ0 to SQn may indicate the plurality of host devices 20.

The controller 100 may control the nonvolatile memory device 200 to perform an operation corresponding to the fetched request RQ. For example, the controller 100 may control the nonvolatile memory device 200 to perform a write, read or erase operation according to the property of the fetched request RQ.

The credit generator 120 may generate a total credit TC corresponding to the total sum of credits allocated to the plurality of queues SQ0 to SQn, and allocate credits to the respective queues based on buffer access patterns INF_BAP of operations corresponding to the requests RQ fetched from the respective queues.

In an embodiment, the buffer access patterns INF_BAP may be generated based on the numbers of requests RQ received from the respective host devices 20 or the respective queues SQ0 to SQn. Furthermore, the buffer access patterns INF_BAP may be generated based on the numbers of requests RQ stored in the respective queues SQ0 to SQn. That is, the credit generator 120 may refer to the numbers of requests RQ stored in the respective queues at that time, when allocating the credits. The credit generator 120 may allocate a relatively large number of credits to a queue in which a relatively large number of requests RQ are currently stored. In an embodiment, the credit may indicate the ratio of the requests RQ fetched from the corresponding queue with respect to the entire queues. In another embodiment, the credit may indicate the number of buffer memories 151 allocated to the corresponding queue or the number of slots included in the buffer memory 151. In another embodiment, the credit may indicate the number of requests RQ which are consecutively fetched in the corresponding queue.

The controller 100 may decide the order of the requests RQ fetched from the host device 20, based on the credits allocated the respective queues. That is, the controller 100 may decide the order in which the requests RQ stored in the respective queues are fetched and the operations corresponding to the requests RQ are performed.

The control component 130 may include a micro control unit (MCU) or a central processing unit (CPU). The control component 130 may process a request received from the host device 20. In order to process the request, the control component 130 may drive a code-based instruction or algorithm loaded to the RAM 150, i.e., firmware (FW), and control internal function blocks and the nonvolatile memory device 200.

The control component 130 may include a buffer manager 131. The buffer manager 131 may decide priority information INF_PRT given to the respective host devices 20 based on request information INF_RQ. Target data DT may indicate data corresponding to a target operation which is performed according to the request RQ. For example, when the operation corresponding to the request RQ is a write operation, the controller 100 may receive the target data DT from the host device 20 through the host interface 110. Then, the controller 100 may buffer the received target data DT in a specific position of the buffer memory 151, and then control the memory control component 160 to store the target data DT at a specific position of the nonvolatile memory device 200. For another example, when the operation corresponding to the request RQ is a read operation, the controller 100 may receive the target data DT from the nonvolatile memory device 200 through the memory control component 160. Then, the controller 100 may buffer the received target data DT in a specific position of the buffer memory 151, and transfer the target data DT to the host device 20 through the host interface 110. In an embodiment, the buffer access pattern INF_BAP may be decided according to the number of times that an operation corresponding to the request RQ fetched from each of the queues in the host device 20 (or each of the host devices) uses the buffer memory 151. In an embodiment, the buffer access pattern INF_BAP may be decided according to the ratio of the number of times that the operation corresponding to the request RQ fetched from the corresponding queue uses the buffer memory 151. That is, a relatively large number of credits may be allocated to a queue (or host device) with a high ratio of number of times that the buffer memory 151 is used, and a relatively small number of credits may be allocated to a queue (or host device) with a low ratio of number of times that the buffer memory 151 is used.

The buffer manager 131 may decide the priority information INF_PRT based on the property of the target data DT or the request RQ. For example, the property of the target data DT may be decided according to whether the operation corresponding to the request RQ is a read operation or write operation. In an embodiment, a relatively large number of credits may be allocated to a queue in which a relatively large number of requests RQ corresponding to a read operation are stored.

The buffer manager 131 may allocate a buffer required for performing the operation based on the request RQ received from the host device 20. For example, when a write request is received from the host device 20, the buffer manager 131 may allocate the buffer memory 151 to temporarily store target data DA which are received from the host device 20 and will be stored in the nonvolatile memory device 200. For another example, when a read request is received from the host device 20, the buffer manager 131 may allocate the buffer memory 151 to temporarily store target data DA which are received from the nonvolatile memory device 200 and will be transferred to the host device 20.

When the operation based on the request RQ received from the host device 20 is performed, the buffer manager 131 may acquire access information to access the buffer memory 151, and generate and output the priority information INF_PRT based on a monitoring result of the access information. In other words, request information INF_RQ which is the basis for the priority information INF_PRT may include the access information. Specifically, the buffer manager 131 may acquire the pattern in which the buffer memory 151 is accessed by the operation based on the request RQ fetched from each of the queues (or the host devices), and generate the priority information INF_PRT based on the acquired pattern. For example, the buffer manager 131 may monitor the number of times that the operation corresponding to the request RQ fetched from the queue (or host device) accesses the buffer memory 151. For another example, the buffer manager 131 may monitor the type of the operation corresponding to the request RQ fetched from the queue (or host device). The type of the operation may include a write operation, read operation and erase operation. However, the present embodiment is not limited to those exemplary operations.

In an embodiment, the controller 100 may include the temporary queue storage device 140. The temporary queue storage device 140 may correspond to each of the queues (or the host devices), and receive the corresponding request among requests received from the queues (or the host devices).

In an embodiment, the credit generator 120 may generate credits to provide to the respective queues (or the respective host devices), based on the numbers of requests RQ stored in the temporary queue storage devices 140.

The RAM 150 may include a dynamic RAM (DRAM) or static RAM (SRAM). The RAM 150 may store firmware FW driven by the control component 130. The RAM 150 may store data required for driving the firmware FW, for example, meta data. That is, the RAM 150 may operate as a working memory of the control component 130.

In an embodiment, the RAM 150 may include the buffer memory 151. The buffer memory 151 may temporarily store the target data DT which are to be transmitted to the nonvolatile memory device 200 from the host device 20 or transmitted to the host device 20 from the nonvolatile memory device 200. The buffer memory 151 may include a RAM such as DRAM or SRAM. In an embodiment, the buffer manager 131 may determine priorities to the host devices 20 based on the credits, and store the requests RQ in the buffer memory 151 according to the priorities determined to the host devices 20.

The memory control component 160 may control the nonvolatile memory device 200 according to control of the control component 130. The memory control component 160 may be referred to as a memory interface. The memory control component 160 may provide control signals to the nonvolatile memory device 200. The control signals may include a command, address and control signal for controlling the nonvolatile memory device 200. The memory control component 160 may provide data to the nonvolatile memory device 200, or receive data from the nonvolatile memory device 200.

In an embodiment, the control component 130 may set the priority of a command CMD to transfer to the nonvolatile memory device 200, based on the credits generated by the credit generator 120, and the memory control component 160 may transfer the command CMD to the nonvolatile memory device 200 based on the set priority.

The nonvolatile memory device 200 may be implemented with any one of various nonvolatile memory devices such as a NAND flash memory device, a NOR flash memory device, a ferroelectric RAM (FRAM) using a ferroelectric capacitor, a magnetic RAM (MRAM) using a tunneling magneto-resistive (TMR) film, a phase change RAM (PRAM) using chalcogenide alloys, and a resistive RAM (ReRAM) using a transition metal oxide.

The nonvolatile memory device 200 may include a memory cell array (e.g., memory cell array 210 of FIG. 11). The memory cell array may include memory cells which are configured on a hierarchical memory cell group basis or memory cell basis from an operational viewpoint or physical (or structural) viewpoint. For example, memory cells which are coupled to the same word line and read/written (or programmed) at the same time may constitute a page. Memory cells constituting a page may be referred to as a “page” for convenience. Furthermore, memory cells which are erased at the same time may constitute a memory block. The memory cell array may include a plurality of memory blocks, and each of the memory blocks may include a plurality of pages.

The controller 100 determines priorities to requests received from the respective queues SQ0 to SQ(n) (or host devices 20) and processes the requests according to the priorities. The controller 100 may include the credit generator 120, the buffer manager 131 and the buffer memory 151. The credit generator 120 may generate credits to provide to the respective queues SQ0 to SQ(n) (or host devices 20) based on the numbers of requests received from the respective queues SQ0 to SQ(n) (or host devices 20). The buffer manager 131 may determine the priorities to the respective queues SQ0 to SQ(n) (or host devices 20) based on the credits. The buffer memory 151 may store the requests according to the priorities determined to the queues SQ0 to SQ(n) (or host devices 20).

In an embodiment, the controller 100 may include the plurality of temporary queue storage devices 140 which are configured to correspond to the respective host devices 20, and receive the corresponding requests among the requests of the host devices 20. The credit generator 120 may generate the credits to provide to the respective host devices 20 based on the numbers of requests stored in the respective temporary queue storage devices 140. In another embodiment, the buffer manager 131 may determine the priorities to the respective host devices 20 based on the credits and the properties of the requests.

In an embodiment, the controller 100 may further include a processing region calculator which calculates a memory region allocated to operations corresponding to requests received from the host devices 20, based on the requests. The buffer manager 131 may determine priorities to the respective host devices 20 based on the credits and the memory region. In another embodiment, the buffer manager 131 may determine priorities to the respective host devices 20 based on the credits, the memory region and the properties of the requests. The properties of the requests may be decided according to whether the operation corresponding to the requests is a read operation or write operation. For example, the buffer manager 131 may determine the properties of the requests based on the ratio of the number of times that the operation corresponding to the requests received from the respective host devices 20 is a read operation to the number of times that the operation is a write operation.

In an embodiment, the credit generator 120 may reallocate credits to the respective host devices 20 in each set cycle. When the credits are reallocated, the total credit of the host devices 20 may be retained. This configuration will be described later in more detail.

The memory system 10 may include the controller 100 configured to receive requests from the plurality of host devices 20 and the nonvolatile memory device 200. The nonvolatile memory device 200 may receive a command corresponding to a request from the controller 100, and perform an operation corresponding to the command according to control of the controller 100. The controller 100 may include the credit generator 120, the control component 130 and the memory control component 160. The credit generator 120 may generate credits to provide to the respective host devices 20 based on the numbers of requests received from the respective host devices 20. The control component 130 may set the priorities of commands to transfer to the nonvolatile memory device 200, based on the credits. The memory control component 160 may transfer the commands to the nonvolatile memory device 200 based on the set priorities.

In an embodiment, the control component 130 may further include the buffer memory 151 configured to store the requests received from the host devices 20. The control component 130 may determine the priorities to the respective host devices 20 based on the credits, and store the requests RQ in the buffer memory 151 according to the determined priorities.

In an embodiment, the memory control component 160 may flush the commands corresponding to the requests stored in the buffer memory 151 into the nonvolatile memory device 200. The credit generator 120 may reallocate credits to the respective host devices 20 after the commands are flushed into the nonvolatile memory device 200. This configuration will be described later in detail.

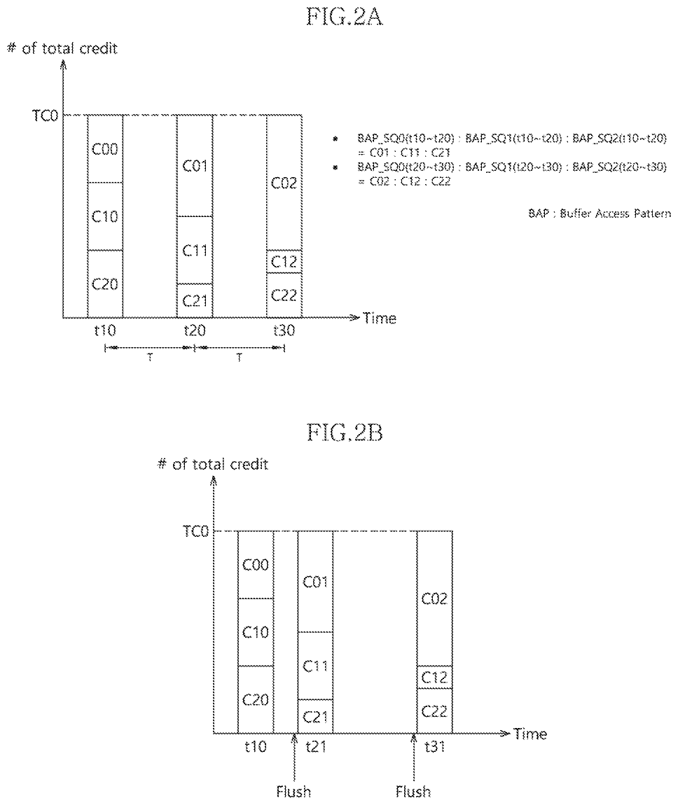

FIG. 2A illustrates an operation in which credits are reallocated to the respective queues in each set cycle. As described above with reference to FIG. 1, the credit generator 120 may allocate credits to the respective queues (or the respective host devices 10) based on the buffer access patterns INF_BAP. FIGS. 2A, 2B and 3 are based on the supposition that the one host device 20 includes three queues SQ0, SQ1 and SQ2, and credits C0n, credits C1n and credits C2n are allocated to the respective queues SQ0, SQ1 and SQ2, where n=0, 1, 2.

Referring to FIG. 2A, the credit generator 120 may reallocate the credits to the respective queues in each set cycle T. At time t10, the credit generator 120 may allocate the initial credits to the respective queues. For example, the credit generator 120 may allocate the credits C00, C10 and C20 to the respective queues SQ0, SQ1 and SQ2. In this case, an equal number of credits are allocated; that is, each of the credits C00, C10 and C20 represents the same number.

As illustrated in FIG. 2A, credits may be reallocated to the respective queues at times t20 and t30 which are sequentially separated by the cycle T after the initial credits are allocated at time t10. The credits may be decided according to the buffer access patterns INF_BAP based on the requests fetched from the respective queues in the previous cycle. The credits may be increased, decreased or equally allocated in each cycle T.

In an embodiment, the buffer access patterns INF_BAP may be decided in proportion to the numbers of times that the operations corresponding to the requests fetched from the plurality of queues SQ0, SQ1 and SQ2 have accessed the buffer memory 151 during the immediately previous cycle T. The credits allocated to the respective queues SQ0, SQ1 and SQ2 may be decided in proportion to the buffer access patterns INF_BAP. That is, as illustrated in FIG. 2A, the credits C01, C11 and C21 allocated at time t20 and the credits C02, C12 and C22 allocated at time t30 may satisfy Equations 1 and 2 below, respectively.

BAP_SQ0(t10˜t20):BAP_SQ1(t10˜t20):BAP_SQ2(t10˜t20)=C01:C11:C21 [Equation 1]

BAP_SQ0(t20˜t30):BAP_SQ1(t20˜t30):BAP_SQ2(t20˜t30)=C02:C12:C22 [Equation 2]

At time t20, when the total credit TC0 is 100 and BAP_SQ0(t10˜t20), BAP_SQ1(t10˜t20) and BAP_SQ2(t10˜t20) are 200, 200 and 100, respectively, the credits C01, C1 and C21 may be set to 40, 40 and 20, respectively. At time t30, when BAP_SQ0(t20˜t30), BAP_SQ1(t20˜t30) and BAP_SQ2(t20˜t30) are 1000, 400 and 600, the credits C02, C12 and C22 may be set to 50, 20 and 30, respectively.

As illustrated in FIG. 2A, the credit generator 120 may retain the total credit TC0 corresponding to the sum of the credits, and reallocate credits to the respective queues within the total credit TC0, based on the buffer access patterns INF_BAP during the immediately previous cycle.

FIG. 2B illustrates an operation in which credits are reallocated to the respective queues after data stored in the buffer memory 151 of FIG. 1 are flushed into the nonvolatile memory device 200.

Referring to FIG. 2B, the controller 100 of FIG. 1 may flush the target data DT buffered in the buffer memory 151 such that the target data DT are stored in a specific position of the nonvolatile memory device 200 (or the host device 20). The credit generator 120 may reallocate credits after the target data DT stored in the buffer memory 151 are flushed. The target data DT stored in the buffer memory 151 may be flushed when the buffer memory 151 is full. Alternatively, the target data DT may be flushed according to a request of the host device 20.

At time t10, the credit generator 120 may allocate the initial credits to the respective queues. For example, the credit generator 120 may allocate the credits C00, C10 and C20 to the queues SQ0, SQ1 and SQ2, respectively. In this case, an equal number of credits is allocated as the credits C00, C10 and C20. Furthermore, at times t21 and t31, the credits C01, C11, C21, C02, C12 and C22 may be allocated in the same manner as FIG. 2A, and Equations 1 and 2 may be applied in the same manner.

In an embodiment, times t21 and t31 may correspond to times after the target data DT stored in the buffer memory 151 are flushed. That is, the times at which the credits are reallocated may not correspond to intervals of the set cycle T. At the times t21 and t31, the credits may be reallocated after the target data DT stored in the buffer memory 151 are flushed. The time required until the credits are reallocated after the target data DT are flushed may be set and changed any time.

FIG. 3 illustrates an operation in which the total credit is variably generated when credits are reallocated. Referring to FIG. 3, at time t30, credits C03, C13 and C23 are allocated to the queues SQ0, SQ1 and SQ2, respectively. The sum of the credits at time t30 corresponds to a total credit TC1.

The credit generator 120 of FIG. 1 may adjust the total credit based on the buffer access patterns INF_BAP, when reallocating the credits. At time t40, credits C04, C14 and C24 may be reallocated to the queues based on the buffer access patterns INF_BAP determined during a period from t30 to t40, i.e. one period T. The total credit may be variably set based on the buffer access patterns INF_BAP. For example, when the sum of access counts in all the queues is increased during one cycle, and the buffer access patterns INF_BAP are decided according to the number of times that the buffer memory 151 is accessed, the buffer access patterns INF_BAP may be changed according to the increase in the sum of the access counts. Thus, the total credit may increase. At time t40, the total credit may be changed to a total credit TC2, which has increased from the total credit TC1 at time t30. In other words, at time t40, the sum total of the credits C04, C14 and C24 allocated to the queues SQ0, SQ1 and SQ2, i.e. the total credit TC2 may be greater than the total credit TC1. At time t50, the sum total of credits C05, C15 and C25 allocated to the queues SQ0, SQ1 and SQ2, i.e., a total credit TC3 may be less than the total credit TC2 and the total credit TC1.

As described above with reference to FIG. 2A, the buffer access patterns INF_BAP may be decided in proportion to the numbers of times that the operations corresponding to the requests fetched from the plurality of queues SQ0, SQ1 and SQ2 access the buffer memory 151 during the previous cycle T, and the credits allocated to the respective queues may be decided in proportion to the buffer access patterns INF_BAP. That is, as illustrated in FIG. 3, the credits C04, C14 and C24 allocated at time t40 and the credits C05, C15 and C25 allocated at time t50 may satisfy Equations 3 and 4 respectively.

BAP_SQ0(t30˜t40):BAP_SQ1(t30˜t40):BAP_SQ2(t30˜t40)=C04:C14:C24 [Equation 3]

BAP_SQ0(t40˜t50):BAP_SQ1(t40˜t50):BAP_SQ2(t40˜t50)=C05:C15:C25 [Equation 4]

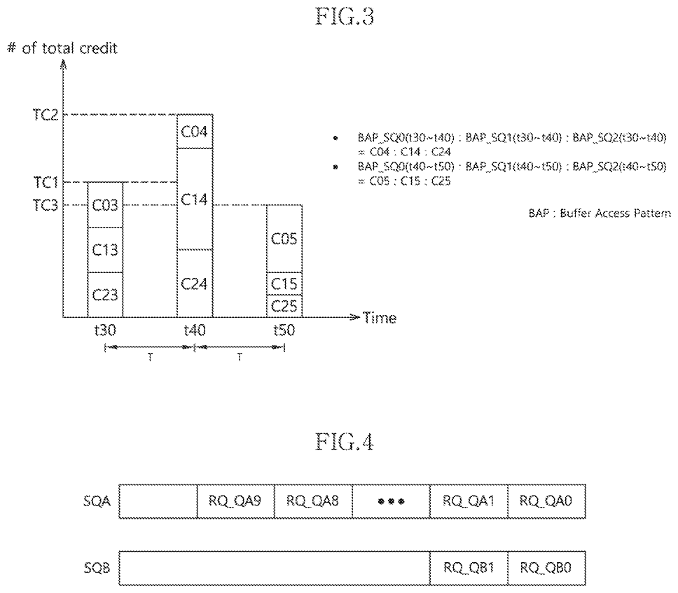

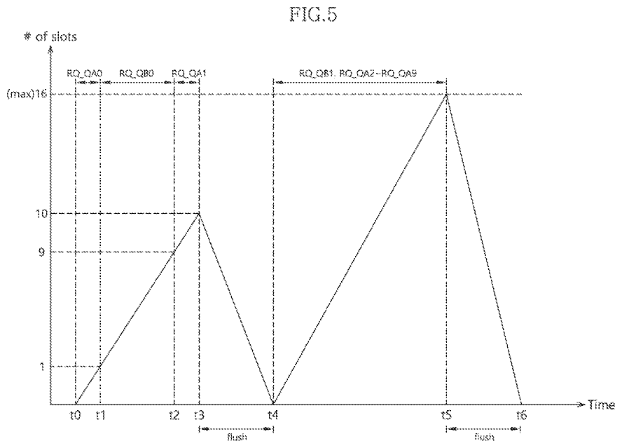

FIG. 4 illustrates an operation in which a plurality of requests is stored in a plurality of queues. FIGS. 4 to 6 are based on the following supposition: the host device 20 of FIG. 1 includes two queues SQA and SQB; requests stored in the queues SQA and SQB were queued in order of a request RQ_QA0, request RQ_QB0, request RQ_QA1, request RQ_QB1, request RQ_QA2, . . . and request RQ_QA9; each of the requests RQ_QA0 to RQ_QA9 stored in the queue SQA has a size of 4 KB; each of the requests RQ_B0 and RQ_B1 stored in the queue SQB has a size of 32 KB; and the buffer memory 151 of the controller 100 in FIG. 1 includes 16 slots which can store the requests RQ and each of which has a storage capacity of 4 KB.

FIG. 5 is a graph illustrating available buffer memory slots based on time, when the requests of FIG. 4 are fetched in a round robin manner to access the buffer memory 151 of FIG. 1. A process in which a plurality of requests are fetched in a round robin manner and stored in the buffer memory 151 of the controller 100 will be described with reference to FIGS. 1, 4 and 5.

The round robin method or round robin scheduling may indicate that no priorities are determined to queues, and requests stored in the respective queues are fetched according to the order in which the requests were queued. According to the round robin method, the requests stored in the queues SQA and SQB may be fetched and provided to the controller 100 in order of the request RQ_QA0, the request RQ_QB0, the request RQ_QA1, the request RQ_QB1, the request RQ_QA2, . . . and the request RQ_QA9.

During a period from t0 to t1, the request RQ_QA0 stored in the queue SQA may be fetched, and one slot (having 4 KB capacity) of the buffer memory 151 may be required for the request RQ_QA0. Thus, 15 slots may remain in the buffer memory 151 at time t1. During a period from t1 to t2, the request RQ_QB0 stored in the queue SQB may be fetched, and eight slots (having a total capacity of 32 KB) of the buffer memory 151 may be used. Therefore, seven slots may remain in the buffer memory 151. During a period from t2 to t3, the request RQ_QA1 stored in the queue SQA may be fetched, and one slot (of 4 KB capacity) of the buffer memory 151 may be used. Therefore, six slots may remain in the buffer memory 151. According to the round robin method, the request RQ_QB1 stored in the queue SQB needs to be subsequently fetched. However, the buffer memory 151 may not have an available slot to store the request RQ_QB1. Therefore, in order to fetch the request RQ_QB1, a flush operation may be performed during a period from t3 to t4. In other words, since the size of the request RQ_QB1 is 32 KB and the remaining capacity of the buffer memory 151 is 24 KB, the requests and data stored in the buffer memory 151 may be flushed and stored in specific positions of the nonvolatile memory device 200. Then, a fetch operation for the rest requests may be performed.

After the requests stored in the buffer memory 151 are flushed, the 16 slots corresponding to the maximum storage capacity of the buffer memory 151 may be all emptied. Then, during a period from t4 to t5, the request RQ_QB1 (e.g., 32 KB of data) stored in the queue SQB and the requests RQ_QA2 to RQ_QA9 (e.g., 4 KB each) stored in the queue SQA may be sequentially fetched, and operations corresponding to the respective requests may be performed. The request RQ_QB1 of 32 KB corresponds to 8 slots, and the requests RQ_QA2 to RQ_QA9 of 32 KB total correspond to 8 slots.

When the plurality of requests stored in the plurality of queues are fetched according to the order in which the requests were queued to the queues or a fixed order, the fetch operation for the requests and the operations corresponding to the requests may be delayed as in the period from t3 to t4 in FIG. 5. Specifically, the requests having different workload characteristics (for example, a write request and a read request) may have different sizes, and the buffer memory 151 may be flushed when the next request has a size greater than a remaining storage capacity of the buffer memory 151 even though the buffer memory 151 is not full. As a result, an operation delay may occur during the period in which the buffer memory 151 is flushed.

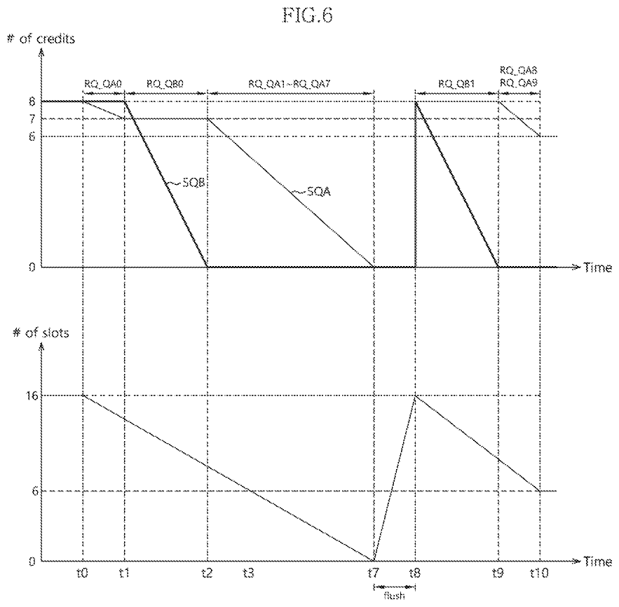

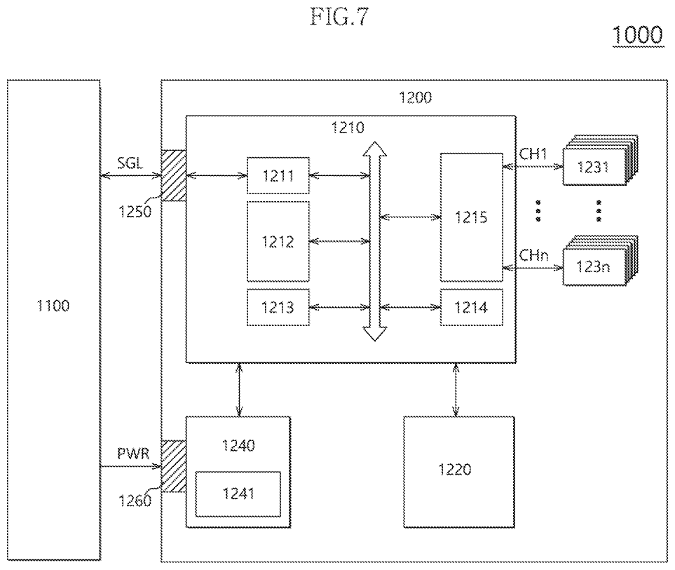

FIG. 6 is a graph illustrating credits of the respective queues and available buffer memory slots, when a plurality of requests (e.g., the requests of FIG. 4) are fetched to access a buffer memory (e.g., buffer memory 151 of FIG. 1) in accordance with an embodiment. FIG. 6 is based on the supposition that eight credits are allocated to each of the queues SQA and SQB. A request of 4 KB may be fetched for one credit, and credits may be reallocated after data stored in the buffer memory 151 are flushed. That is, although credits allocated to any one queue are all consumed, requests stored in the other queue having remaining credits may be fetched until the slots of the buffer memory 151 are full, and operations corresponding to the fetched requests may be performed. Such process will be described with reference to FIGS. 1, 4 and 6.

Referring to FIG. 6, during a period from t0 to t1, the request RQ_QA0 may be fetched. Since the size of the request RQ_QA0 is 4 KB, one credit of the queue SQA may be consumed, while one slot of the buffer memory 151 is filled. The credits of the queue SQB may not be increased or decreased, but eight credits may be retained in the queue SQB.

During a period from t1 to t2, the request RQ_QB0 may be fetched. Since the size of the request RQ_QB0 is 32 KB, eight credits may be consumed in the queue SQB. That is, the credits of the queue SQB may be all consumed during the period from t1 to t2. During the corresponding period, eight slots among the slots of the buffer memory 151 may be filled, and seven slots may remain. The credits of the queue SQA may not be increased or decreased, but seven credits may be retained in the queue SQA.

During a period from t2 to t7, the requests RQ_QA1 to RQ_QA7 may be fetched. That is, after the request RQ_QA1 is fetched, the data stored in the buffer memory 151 may not be flushed due to a lack of slots for an operation of the request RQ_QB1. Instead, the requests corresponding to the remaining credits of the queue SQA may be fetched. As illustrated in FIG. 6, the credits allocated to the queues SQA an SQB may be all consumed at time t7. Credits then may be reallocated by the credit generator 120. When the credits are reallocated, the buffer access patterns INF_BAP of the respective queues SQA and SQB in the period from t0 to t7 may be referred to. FIG. 6 illustrates that the credits allocated to the queues SQA and SQB are all consumed at time t7, while the slots of the buffer memory 151 are all emptied. However, when available slots remain in the buffer memory 151 even though the credits allocated to the queues SQA and SQB are all consumed, the data stored in the buffer memory 151 may not be flushed, but credits may be reallocated. Then, requests corresponding to the remaining credits may be successively fetched.

In accordance with embodiments, the controller and the memory system may adjust the order in which the requests of host devices are fetched based on the workload characteristics of the operations corresponding to the requests, and efficiently allocate the resource of the system.

Furthermore, the controller and the memory system may efficiently use the storage capacity of the buffer memory, thereby minimizing delay time during an operation of fetching the host requests and an operation corresponding to the host requests.

FIG. 7 is a diagram illustrating a data processing system 1000 including a solid state drive (SSD) in accordance with an embodiment. Referring to FIG. 7, the data processing system 1000 may include a host device 1100 and a solid state drive (SSD) 1200.

The SSD 1200 may include a controller 1210, a buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and the like. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-e or PCIe) and universal flash storage (UFS).

The control component 1212 may analyze and process a signal SGL inputted from the host device 1100. The control component 1212 may control operations of internal function blocks according to firmware or software for driving the SSD 1200. The random access memory 1213 may be used as a working memory for driving such firmware or software.

The ECC component 1214 may generate the parity data for data to be transmitted to the nonvolatile memory devices 1231 to 123n. The generated parity data may be stored together with the data in the nonvolatile memory devices 1231 to 123n. The ECC component 1214 may detect an error of the data read out from the nonvolatile memory devices 1231 to 123n, based on the parity data. If a detected error is within a correctable range, the ECC component 1214 may correct the detected error.

The memory interface 1215 may provide control signals such as commands and addresses to the nonvolatile memory devices 1231 to 123n, according to control of the control component 1212. Moreover, the memory interface 1215 may exchange data with the nonvolatile memory devices 1231 to 123n, according to control of the control component 1212. For example, the memory interface 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be properly terminated when a sudden power-off occurs. The auxiliary power supply 1241 may include large capacity capacitors.

The signal connector 1250 may be implemented by any of various types of connectors depending on an interface scheme between the host device 1100 and the SSD 1200.

The power connector 1260 may be implemented by any of various types of connectors depending on a power supply scheme of the host device 1100.

FIG. 8 is a diagram illustrating a data processing system 2000 including a data storage device in accordance with an embodiment. Referring to FIG. 8, the data processing system 2000 may include a host device 2100 and a data storage device 2200.

The host device 2100 may be implemented in the form of a board such as a printed circuit board. Although not shown, the host device 2100 may include internal function blocks for performing the function thereof.

The host device 2100 may include a connection terminal 2110 such as a socket, a slot or a connector. The data storage device 2200 may be mounted to the connection terminal 2110.

The data storage device 2200 may be implemented in the form of a board such as a printed circuit board. The data storage device 2200 may be referred to as a memory module or a memory card. The data storage device 2200 may include a controller 2210, a buffer memory device 2220, nonvolatile memory devices 2231 and 2232, a power management integrated circuit (PMIC) 2240, and a connection terminal 2250.

The controller 2210 may control general operations of the data storage device 2200. The controller 2210 may be configured in the same manner as the controller 1210 shown in FIG. 7.

The buffer memory device 2220 may temporarily store data to be stored in the nonvolatile memory devices 2231 and 2232. Further, the buffer memory device 2220 may temporarily store the data read out from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the data storage device 2200.

The PMIC 2240 may provide the power inputted through the connection terminal 2250, to the inside of the data storage device 2200. The PMIC 2240 may manage the power of the data storage device 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the data storage device 2200. The connection terminal 2250 may be implemented by any of various types of connection terminals depending on an interface scheme between the host device 2100 and the data storage device 2200. The connection terminal 2250 may be disposed on any one side of the data storage device 2200.

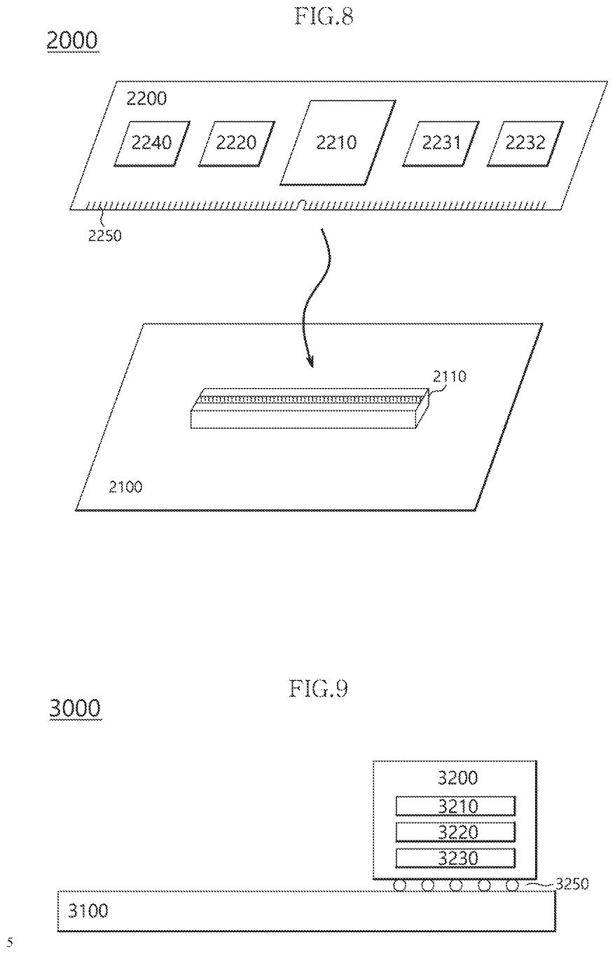

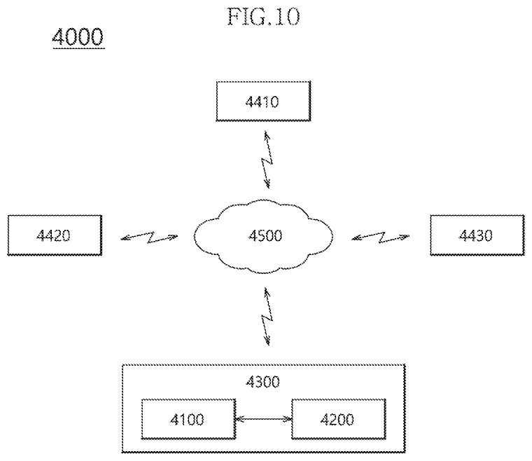

FIG. 9 is a diagram illustrating a data processing system 3000 including a data storage device in accordance with an embodiment. Referring to FIG. 9, the data processing system 3000 may include a host device 3100 and a data storage device 3200.

The host device 3100 may be implemented in the form of a board such as a printed circuit board. Although not shown, the host device 3100 may include internal function blocks for performing the function thereof.

The data storage device 3200 may be implemented as a surface-mounting type package. The data storage device 3200 may be mounted to the host device 3100 through solder balls 3250. The data storage device 3200 may include a controller 3210, a buffer memory device 3220, and a nonvolatile memory device 3230.

The controller 3210 may control general operations of the data storage device 3200. The controller 3210 may be configured in the same manner as the controller 1210 shown in FIG. 7.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as a storage medium of the data storage device 3200.

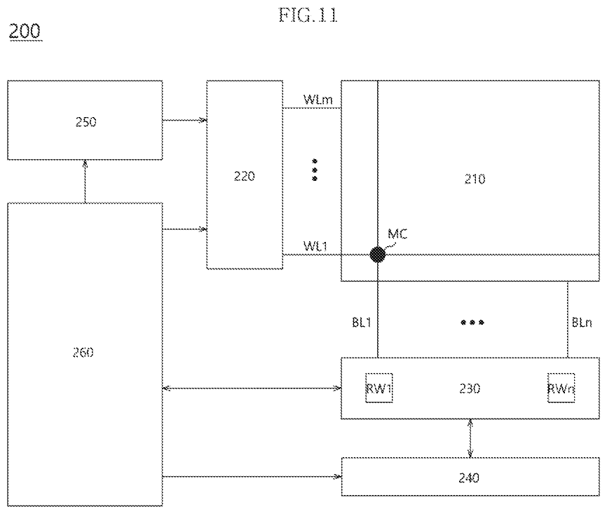

FIG. 10 is a diagram illustrating a network system 4000 including a data storage device in accordance with an embodiment. Referring to FIG. 10, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and a data storage device 4200. The data storage device 4200 may be implemented by the data storage device 10 shown in FIG. 1, the SSD 1200 shown in FIG. 7, the data storage device 2200 shown in FIG. 8 or the data storage device 3200 shown in FIG. 9.

FIG. 11 is a block diagram illustrating a nonvolatile memory device 200 included in a data storage device in accordance with an embodiment. Referring to FIG. 11, the nonvolatile memory device 200 may include a memory cell array 210, a row decoder 220, a data read and write (read/write) block 230, a column decoder 240, a voltage generator 250, and a control logic 260.

The memory cell array 210 may include memory cells MC which are arranged at areas where word lines WL1 to WLm and bit lines BL1 to BLn intersect with each other.

The row decoder 220 may be coupled with the memory cell array 210 through the word lines WL1 to WLm. The row decoder 220 may operate according to the control of the control logic 260. The row decoder 220 may decode an address provided from an external device (not shown) (e.g., controller 100 of FIG. 1). The row decoder 220 may select and drive the word lines WL1 to WLm, based on a decoding result. For instance, the row decoder 220 may provide a word line voltage provided from the voltage generator 250, to the word lines WL1 to WLm.

The data read/write block 230 may be coupled with the memory cell array 210 through the bit lines BL1 to BLn. The data read/write block 230 may include read/write circuits RW1 to RWn respectively corresponding to the bit lines BL1 to BLn. The data read/write block 230 may operate according to control of the control logic 260. The data read/write block 230 may operate as a write driver or a sense amplifier according to an operation mode. For example, in a write operation, the data read/write block 230 may operate as a write driver which stores data provided from the external device, in the memory cell array 210. For another example, in a read operation, the data read/write block 230 may operate as a sense amplifier which reads out data from the memory cell array 210.

The column decoder 240 may operate according to the control of the control logic 260. The column decoder 240 may decode an address provided from the external device. The column decoder 240 may couple the read/write circuits RW1 to RWn of the data read/write block 230 respectively corresponding to the bit lines BL1 to BLn with data input/output lines (or data input/output buffers), based on a decoding result.

The voltage generator 250 may generate voltages to be used in internal operations of the nonvolatile memory device 200. The voltages generated by the voltage generator 250 may be applied to the memory cells of the memory cell array 210. For example, in a program operation, a generated program voltage may be applied to a word line of memory cells for which the program operation is to be performed. For still another example, in an erase operation, a generated erase voltage may be applied to a well area of memory cells for which the erase operation is to be performed. For still another example, in a read operation, a generated read voltage may be applied to a word line of memory cells for which the read operation is to be performed.

The control logic 260 may control general operations of the nonvolatile memory device 200, based on control signals provided from the external device. For example, the control logic 260 may control the read, write and erase operations of the nonvolatile memory device 200.

While various embodiments have been illustrated and described, it will be understood by those skilled in the art in light of the present disclosure that the embodiments described are examples only. Accordingly, the operating method of a data storage device described herein are not limited based on the described embodiments. Rather, the present invention encompasses all modifications and variations that fall within the scope of the claims.

What is claimed is:

1. A controller which receives requests from a plurality of host devices, and processes the requests according to priorities, the controller comprising:
a credit generator configured to generate credits for the respective host devices based on the numbers of requests received from the respective host devices;
a buffer manager configured to determine priorities for the respective host devices based on the credits; and
a buffer memory configured to store the requests according to the priorities for the host devices.

2. The controller according to claim 1, further comprising a plurality of temporary queue storage devices, corresponding to the respective host devices, each configured to receive and store the requests from the corresponding host device,
wherein the credit generator generates the credits for the respective host devices based on the numbers of requests stored in the temporary queue storage devices.

3. The controller according to claim 1, further comprising a processing region calculator configured to calculate a memory region allocated for an operation corresponding to the requests based on the requests received from the host devices,
wherein the buffer manager determines the priorities for the respective host devices based on the credits and the memory region.

4. The controller according to claim 3, wherein the buffer manager determines the priorities for the respective host devices based on the credits, the memory region and the properties of the requests.

5. The controller according to claim 4, wherein the properties are decided according to whether the operation corresponding to the requests is a read operation or write operation.

6. The controller according to claim 5, wherein the buffer manager determines the properties based on the ratio of the number of times that the operation corresponding to the requests received from the respective host devices is a read operation to the number of times that the operation is a write operation.

7. The controller according to claim 1, wherein the credit generator generates the credits for the respective host devices based on the numbers of times that the requests are received from the respective host devices.

8. The controller according to claim 1, wherein the credit generator reallocates credits for the respective host devices in each set cycle.

9. The controller according to claim 8, wherein the credit generator retains a total credit of the host devices, when reallocating the credits.

10. A memory system comprising:
a controller configured to receive requests from a plurality of host devices; and
a nonvolatile memory device configured to receive commands corresponding to the requests from the controller, and perform operations corresponding to the commands according to control of the controller,
wherein the controller comprises:
a credit generator configured to generate credits for the respective host devices based on the numbers of requests received from the respective host devices;
a control component configured to determine priorities of the commands to transfer to the nonvolatile memory device, based on the credits; and
a memory control component configured to transfer the commands to the nonvolatile memory device based on the determined priorities.

11. The memory system according to claim 10, wherein the control component further comprises a buffer memory configured to store the requests received from the host devices, and
wherein the control component determines priorities for the respective host devices based on the credits, and stores the requests in the buffer memory according to the priorities.

12. The memory system according to claim 11, wherein the controller further comprises a plurality of temporary queue storage devices, corresponding to the respective host devices, each configured to receive and store the requests from the corresponding host device, and
wherein the credit generator generates the credits for the respective host devices based on the numbers of requests stored in the temporary queue storage devices.

13. The memory system according to claim 11, wherein the controller further comprises a processing region calculator configured to calculate a memory region allocated for an operation corresponding to the requests based on the requests received from the host devices, and
wherein the control component determines the priorities to the respective host devices, based on the credits and the memory region.

14. The memory system according to claim 13, wherein the control component determines the priorities to the respective host devices, based on the credits, the memory region and the properties of the requests.

15. The memory system according to claim 14, wherein the properties are decided according to whether the operation corresponding to the requests is a read operation or write operation.

16. The memory system according to claim 15, wherein the control component determines the properties based on the ratio of the number of times that the operation corresponding to the requests received from the respective host devices is a read operation to the number of times that the operation is a write operation.

17. The memory system according to claim 11, wherein the credit generator generates the credits for the respective host devices, based on the numbers of times that the requests are received from the respective host devices.

18. The memory system according to claim 11, wherein the credit generator reallocates credits for the respective host devices in each set cycle.

19. The memory system according to claim 11, wherein the credit generator retains a total credit of the host devices, when reallocating the credits.

20. The memory system according to claim 11, wherein the memory control component flushes the commands corresponding to the requests stored in the buffer memory to the nonvolatile memory device, and
wherein the credit generator reallocates credits for the respective host devices after the commands are flushed to the nonvolatile memory device.
